(19) United States
(12) Patent Application Publication
(10) Pub. No.: US 2012/0040819 A1
(43) Pub. Date: Feb. 16, 2012

(54) METHOD OF PRODUCING PHOTOCATALYST LAYER

(75) Inventor: Norio Matsuda, Saitama (JP)

(73) Assignee: PIONEER CORPORATION, Kanagawa (JP)

(21) Appl. No.: 13/265,960

(22) PCT Filed: Apr. 24, 2009
(86) PCT No.: PCT/JP2009/058119

§ 371 Date: Oct. 24, 2011

(51) Int. Cl. B01J 37/34; B01J 21/06

(52) U.S. Cl. 502/5

(57) ABSTRACT

A method of producing a photocatalyst layer can increase a photocatalyst effect without increasing light irradiation energy for activation. The method includes: an irradiation process of irradiating an ultraviolet ray on a titanium oxide layer formed on a substrate, an aqueous photocatalyst solution application process of applying an aqueous photocatalyst solution containing fine particles on the titanium oxide layer to form a photocatalyst layer, and a drying process of drying the photocatalyst layer, wherein the aqueous photocatalyst solution application process is a process of applying the aqueous photocatalyst solution on the titanium oxide layer in such a way that a thickness of the aqueous photocatalyst solution is ununiform.

### TECHNICAL FIELD

The present invention relates to a method of producing a photocatalyst layer.

### BACKGROUND ART

In the past, it is known that photocatalyst has a function of resolving and removing material (dirt) of organic-system or the like based on a photocatalyst effect with irradiation of light. Therefore, it is known that, by forming a photocatalyst layer on a surface of a grass product, a plastic product, or the like, dirt adhered to the surface of the grass product, the plastic product, or the like is self-cleaned. As a method of forming such a phtocatalyst layer, for example, there is used a method of applying an ultraviolet ray (ultraviolet light) to a titanium oxide layer having a hydrophilic effect formed on a surface of a substrate, and applying an aqueous solution containing fine particles of titanium oxide having a photocatalyst effect. In the method, an aqueous solution of titanium oxide is uniformly dispersed with the hydrophilic effect, a solvent is evaporated with drying, and a thin layer of fine particles of titanium oxide is uniformly formed (please see Patent Document No. 1).

### PRIOR ART DOCUMENT

### Patent Document

Patent Document No. 1: Japanese Patent Laid-open No. 2008-260667

### SUMMARY OF THE INVENTION

### Problems to be Solved by the Invention

In the invention disclosed in Patent Document No. 1 mentioned above, however, a thin layer of photocatalyst is uniformly formed on a surface of a substrate as mentioned above, so it is necessary to increase light irradiation energy for activation in order to increase a photocatalyst effect.

The present invention has been accomplished in view of such circumstances, and therefore, it is a main object of the invention to provide a method of producing a photocatalyst layer which can increase a photocatalyst effect without increasing light irradiation energy for activation.

### Means for Solving the Problems

In order to solve the above problems, the invention according to claim 1 relates to a method of producing a photocatalyst layer, comprising:

a light irradiation process of irradiating an ultraviolet ray on a titanium oxide layer formed on a substrate,

an aqueous photocatalyst solution application process of applying an aqueous photocatalyst solution containing fine particles on the titanium oxide layer, and

a drying process of drying the aqueous photocatalyst solution to form a photocalalyst layer,

wherein in the aqueous photocatalyst solution application process, the aqueous photocatalyst solution is applied on the titanium oxide layer in such a way that a thickness of the aqueous photocatalyst solution is ununiform, and

in the drying process, when the drying is carried out, a boundary portion between the aqueous photocatalyst solution and the titanium oxide layer moves gradually from a portion of the aqueous photocatalyst solution whose thickness is thin.

### BRIEF DESCRIPTION OF DRAWINGS

FIG. 1 is a flowchart of explaining a method of producing a phtocatalyst layer in accordance with a first embodiment.

FIG. 2 is a schematic cross-sectional view of showing a substrate and a titanium oxide layer in the first embodiment.

FIG. 3 is a schematic view of showing that light is irradiated.

FIG. 4 is a schematic view of showing that an aqueous photocatalyst solution is applied.

FIG. 5 is a schematic cross-sectional view of a photocatalyst layer.

FIG. 6 is a schematic view of a substrate and a titanium oxide layer seen from the above.

FIG. 7 is a schematic view of a phtocatalyst layer seen from the above.

FIG. 8 is a flowchart of explaining a method of producing a phtocatalyst layer in accordance with a second embodiment.

FIG. 9 is a schematic cross-sectional view of showing a substrate and a titanium oxide layer in the second embodiment.

FIG. 10 is a schematic view of showing that light is irradiated.

FIG. 11 is a schematic cross-sectional view of explaining a blocking frame

FIG. 12 is a schematic view of showing that an aqueous phtocatalyst solution is applied.

FIG. 13 is a schematic cross-sectional view of showing a phtocatalyst layer.

FIG. 14 is a schematic view of a photocatalyst layer seen from the above.

### MODE FOR CARRYING OUT THE INVENTION

### First Embodiment

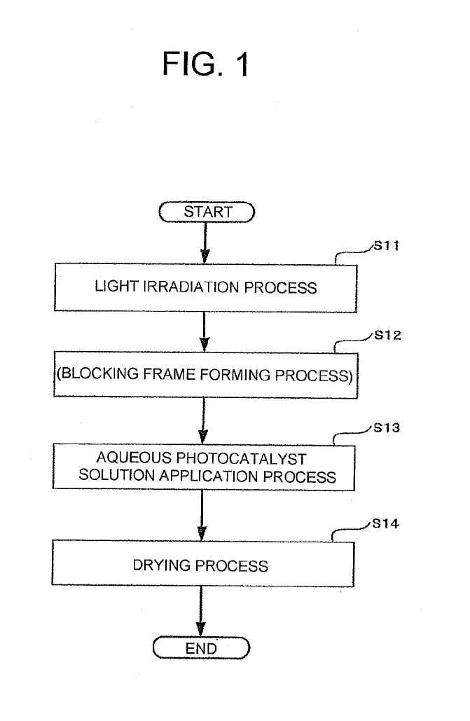

Referring now to FIG. 1 to FIG. 7, a method of producing a photocatalyst layer according to an embodiment of the present invention will be explained.

A method of producing a photocatalyst layer according to the present embodiment comprises, as essential processes, a light irradiation process (step S11), a process of applying an aqueous photocatalyst solution (step S13), and a drying process (step S14), as shown in FIG. 1. Now, each process will be explained in sequence. First, a substrate will be explained.

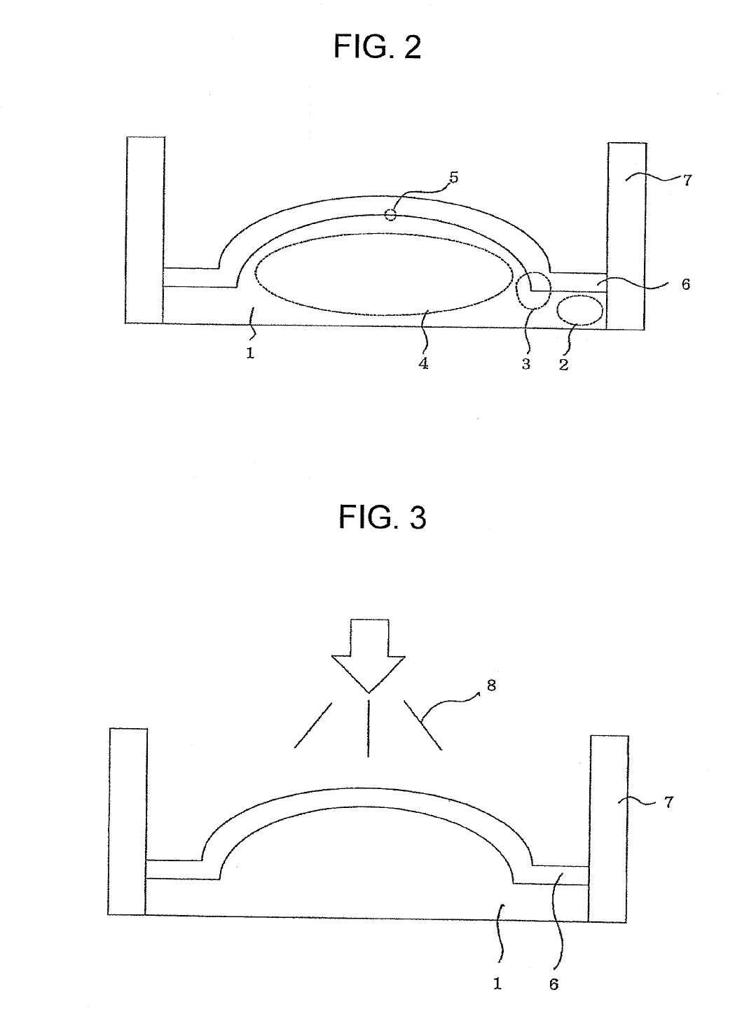

As shown in FIG. 2, material of a substrate 1 is not limited particularly, but grass, resin, or the like is listed.

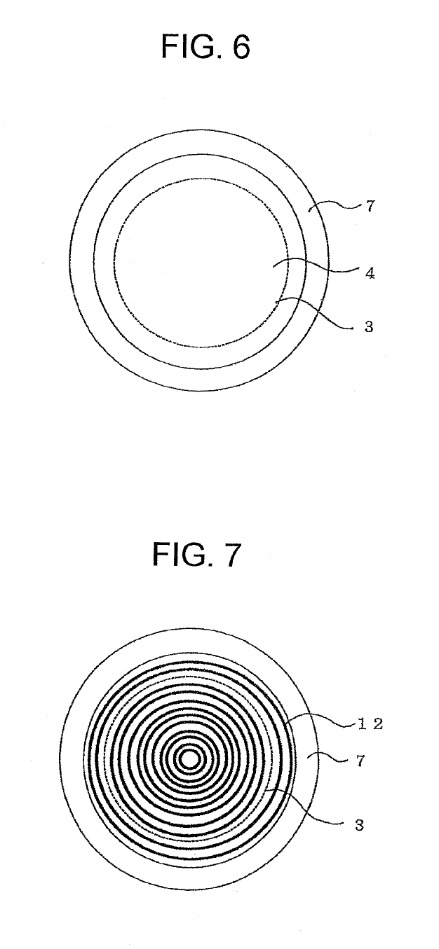

A spherical shape, a plane shape, or the like is listed as a shape of the substrate 1. In the present embodiment, a case where a substrate 1 of a spherical shape is used, and a photocatalyst layer is produced, as shown in FIG. 2, and FIG. 6, will be explained. A substrate of a spherical shape is not limited particularly. For example, as shown in FIG. 2, it may be possible to have a flat portion 2, and a curved portion 4. Further, a thickness of the substrate 1 is not limited particularly.

A titanium-oxide layer 6 formed on the substrate 1 is a layer with a hydrophilic effect, and may comprise, as a main component, titanium oxide of a rutile type.

A thickness of the titanium oxide layer 6 is not limited particularly, but it is sufficient that the titanium oxide layer 6 is as thick as the titanium oxide layer 6 covers an area in which the titanium oxide layer 6 is to be formed. Although a method of forming the titanium oxide layer 6 is not limited particularly, a vapor deposition method, and a spattering method are listed.

### <Light Irradiation Process>

A light irradiation process is a process of irradiating an ultraviolet ray 8 on the titanium oxide layer 6 formed on the substrate 1 (step S11).

As shown in FIG. 3, an irradiation method is a method Of collecting and irradiating the ultraviolet ray 8 emitted from an Hg—Xe lamp or the like on the substrate 1 for a predetermined period of time in such a way that a contact angle (not shown) indicative of a hydrophilic effect is approximately 10 degree for the titanium oxide layer 6 whose main component is titanium oxide of low crystalline. Further, it is preferable that the energy of the ultraviolet ray 8 to be irradiated is, for example, approximately 2800 J/cm² or more, as disclosed in Patent Document No. 1.

### <Blocking Frame Forming Process>

A blocking frame forming process is a process of forming a blocking frame 7 for an aqueous phtocatalyst solution 9 on the periphery of the substrate 1 (step S12). In a case where a member (hereinafter, referred to as “a blocking frame”) of functioning to block the aqueous photocatalyst solution 9 is already provided on the periphery of the substrate 1, this process is not necessary.

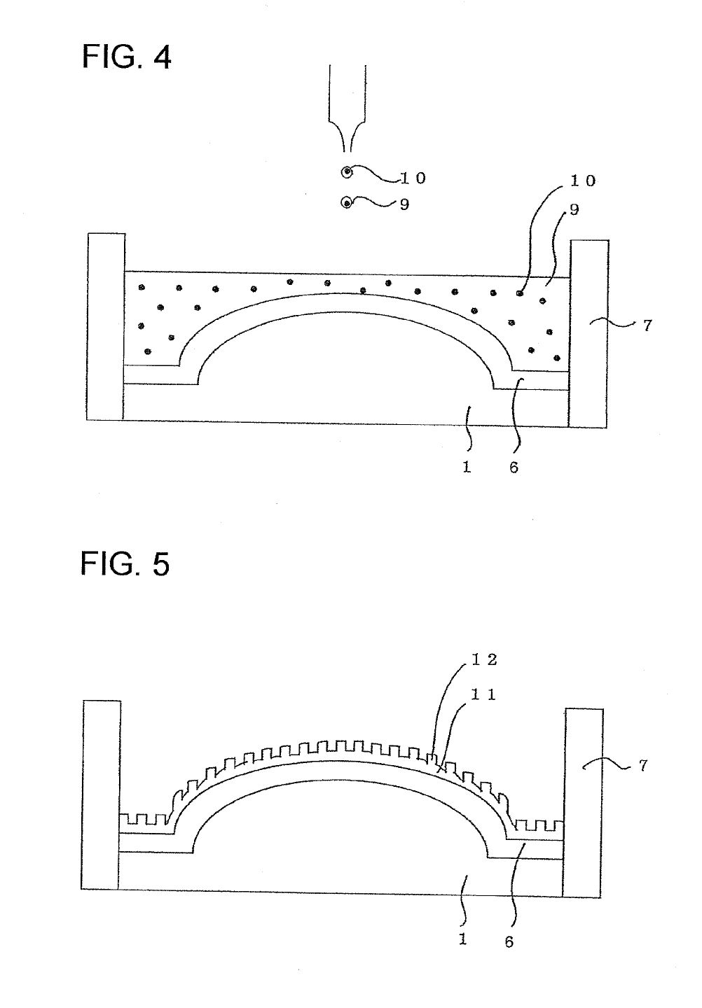

As shown in FIG. 4, the blocking frame 7 is provided to prevent the aqueous photocatalyst solution 9 from leaking to the periphery of the substrate 1 when the aqueous photocatalyst solution 9 is applied on the titanium oxide layer 6.

A shape of the blocking frame 7 is not limited particularly, as long as it has a shape of blocking the aqueous photocatalyst solution 9 on the periphery of the substrate 1, for example, as shown in FIG. 4.

It is preferable that a height of the blocking frame 7 is higher than the position of a top 5 of the substrate 1 of a spherical shape. As mentioned below, in order to apply the aqueous photocatalyst solution 9 to the degree to which the top 5 of the substrate 1 of a spherical shape is covered, by making a height of the blocking frame 7 higher than the position of the top 5 of the substrate 1 of a spherical shape, it is possible to prevent the aqueous photocatalyst solution 9 from leaking to the outside.

### <Process of Applying an Aqueous Photocatalyst Solution>

This process is a process of applying the aqueous photocatalyst solution 9 containing fine particles 10 on the titanium oxide layer 6 to form a photocatalyst layer 11 (step S13).

Here, it is a characterizing feature to apply the aqueous photocatalyst solution containing fine particles to form a photocatalyst layer.

As shown in FIG. 4, the aqueous photocatalyst solution 9 is not limited particularly, as long as it has a phtocatalyst effect. An aqueous solution containing the fine particles 10 and whose main component is titanium oxide of an anatase type having a photocatalyst effect, or the like, is listed. Distilled water, ammonia water, or the like is listed as a solvent.

The concentration of fine particles in the aqueous photocatalyst solution 9 affects a thickness of a film, so it is selected at the request of a necessary thickness of a film.

Thus, by making the aqueous photocatalyst solution contain fine particles, in the case where the drying is carried out in a drying process mentioned below, it is possible to generate a step on a surface of a photocatalyst layer after the aqueous photocatalyst solution has been dried.

As a method of applying the aqueous photocatalyst solution 9, a method of dripping a proper quantity on the substrate 1 with a microsyringe or the like is listed.

Here, it is a characterizing feature to apply the aqueous phtocatalyst solution 9 on the titanium oxide 6 in such a way that a thickness of the aqueous phtocatalyst solution 9 is ununiform.

Since the substrate 1 is a substrate having the flat portion 2 and the curved portion 4, by applying the aqueous photocatalyst solution 9 as shown in FIG. 4, a thickness of the aqueous photocatalyst solution 9 accumulated at the flat portion 2 is different from a thickness of the aqueous photocatalyst solution 9 accumulated at the curved portion 4. Therefore, the aqueous photocatalyst solution 9 is ununiformly applied on the titanium oxide layer 6.

Thus, by applying an aqueous photocatalyst solution on a titanium oxide layer in such a way that a thickness of the aqueous phtocatalyst solution is ununiform, in the case where the drying is carried out in a drying process mentioned below, it is possible to generate a step on a surface of a photocatalyst layer after an aqueous photocatalyst solution has been dried.

Further, it is necessary to apply an amount of the aqueous phtocatalyst solution 9 more than an amount required for the aqueous phtocatalyst solution 9 to be uniformly applied.

Furthermore, as shown in FIG. 4, it may be possible to apply an amount of the aqueous phtocatalyst solution 9 by which the top 5 of the substrate 1 of a spherical shape is covered. Thus, it is also possible to generate a step on a surface in the vicinity of the top of the substrate for the phtocatalyst layer after the aqueous phtocatalyst solution has been dried.

### <Drying Process>

A drying process is a process of drying a photocatalyst layer 11 (step S14).

Although a drying temperature is not limited particularly, it is preferably from a room temperature to approximately 80 degree. A drying period of time is a period of time for which an aqueous potocatalyst solution is evaporated, so it varies with an applied amount of the aqueous potocatalyst solution 9.

Here, a mechanism of producing a step is thought as follows: it is generally known that, when an aqueous fine-particle solution uniformly applied on a plane substrate is dried, a step is generated at a boundary between the aqueous solution and the substrate by a evaporating speed, and the diffusion of concentration of the aqueous solution. In this case, a step is formed in one ring-shape along a shape of the boundary, since the aqueous solution is dispersed in a circular shape on the plane substrate.

It is the present invention that this situation is realized over a whole surface of a plane substrate or a spherical substrate. That is, by applying an aqueous solution on the substrate 1 to the extent to which the aqueous solution is accumulated over the whole of the substrate 1, and making an thickness of the aqueous solution on the substrate be ununiform, a thickness of the aqueous solution moves gradually from a thin portion due to the drying in such a way that a boundary portion moves on the substrate (in the case where the substrate 1 has a spherical shape, a diameter of a ring-shaped boundary portion extends with the top 5 being a center), resulting in the above steps being generated continuously.

Thus, based on the drying, as shown in FIG. 5, and FIG. 7, steps 12 can be generated on a surface of the photocatalyst layer 11.

In the case where a blocking frame is formed in a blocking frame process, there may be provided a process of removing a blocking frame after a drying process.

### Second Embodiment

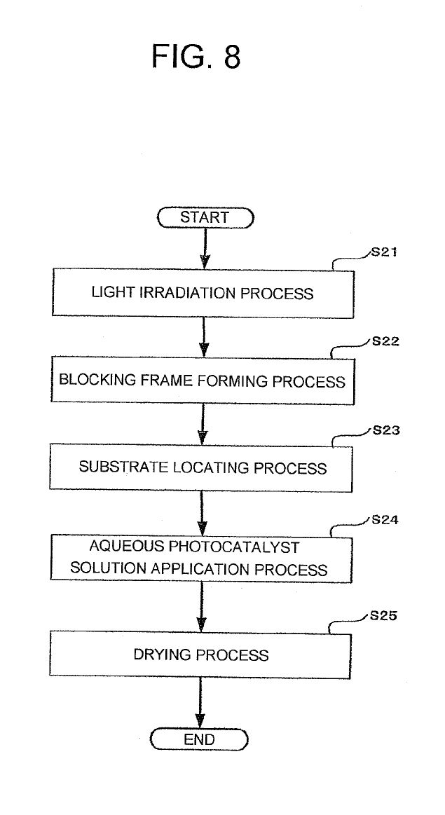

Referring now to FIG. 8 to FIG. 14, a method of producing a photocatalyst layer according to an embodiment of the present invention will be explained.

In the first embodiment, a case where a phtocatalyst layer is produced by using a spherical-shaped substrate has been explained. In the present embodiment, a case where a phtocatalyst layer is produced by using a plane-shaped substrate will be explained hereinafter.

A method of producing a photocatalyst layer according to the present embodiment comprises a light irradiation process (step S21), a process of forming a blocking frame (step S22), a process of locating a substrate (step S23), a process of applying an aqueous photocatalyst solution (step S24), and a drying process (step S25), as shown in FIG. 8. Now, each process will be explained in sequence. First, a substrate on which a titanium oxide layer is formed and which is used in a light irradiation process will be explained.

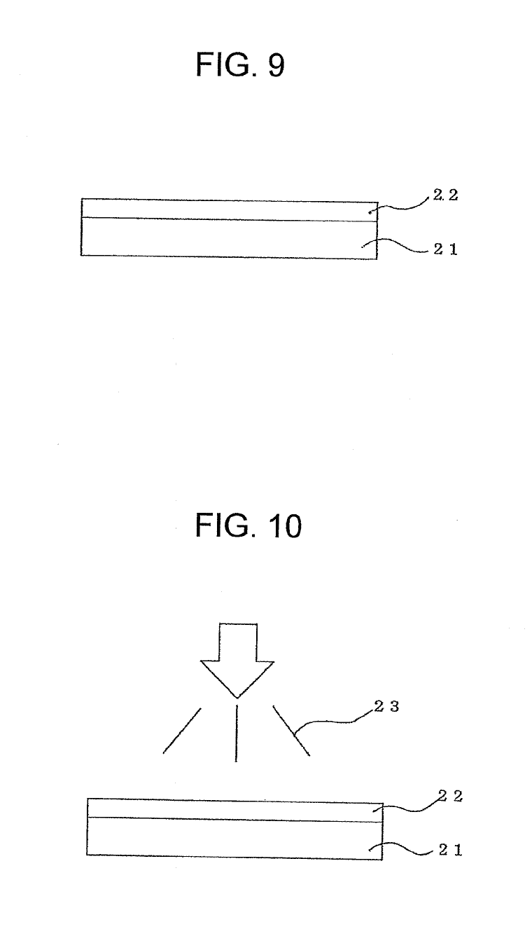

As shown in FIG. 9, material of a substrate 21 is the same as material explained in the first embodiment.

A shape of the substrate 21 is plane, and a thickness of the substrate 21 is not limited particularly.

Material, a thickness, and a forming method of a titanium-oxide layer 22 formed on the substrate 21 are the same as ones explained in the first embodiment.

### <Light Irradiation Process>

A light irradiation process is a process of irradiating an ultraviolet ray on the titanium oxide layer 22 formed on the substrate 21 (step S21).

As shown in FIG. 10, a ultraviolet ray 23 to be irradiated, an irradiation process, and the like are the same as the cases explained in the first embodiment.

### <Blocking Frame Forming Process>

A blocking frame forming process is a process of forming a blocking frame 24 (step S22).

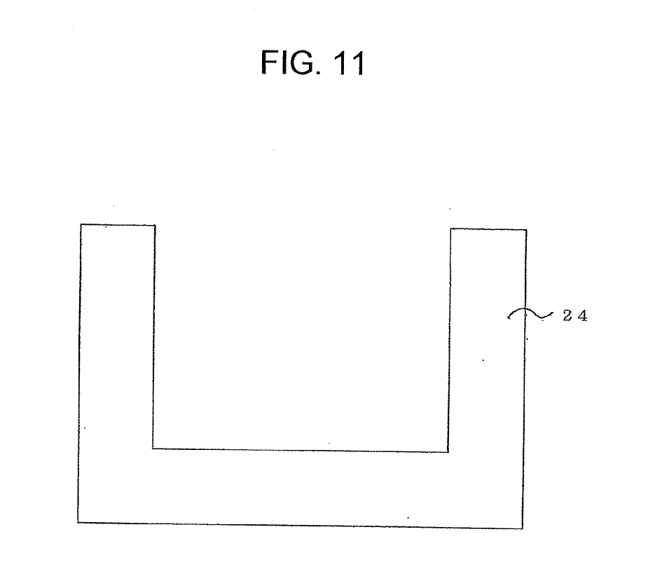

FIG. 11 is a view of showing a blocking frame seen from the above.

A shape of the blocking frame 24 is not limited particularly, as long as it is a shape capable of locating the substrate 21 in an inclined condition, as mentioned below. As shown in FIG. 11, a U-shape is listed.

A size of the blocking frame 24 is not limited particularly, as long as it is a size capable of locating the substrate 21, as mentioned below. A size in which one substrate 21 or a plurality of substrates 21 can be located may be possible.

### <Substrate Locating Process>

A substrate locating process is a process of locating a substrate on a blocking frame formed in a blocking frame forming process in an inclined condition (step S23).

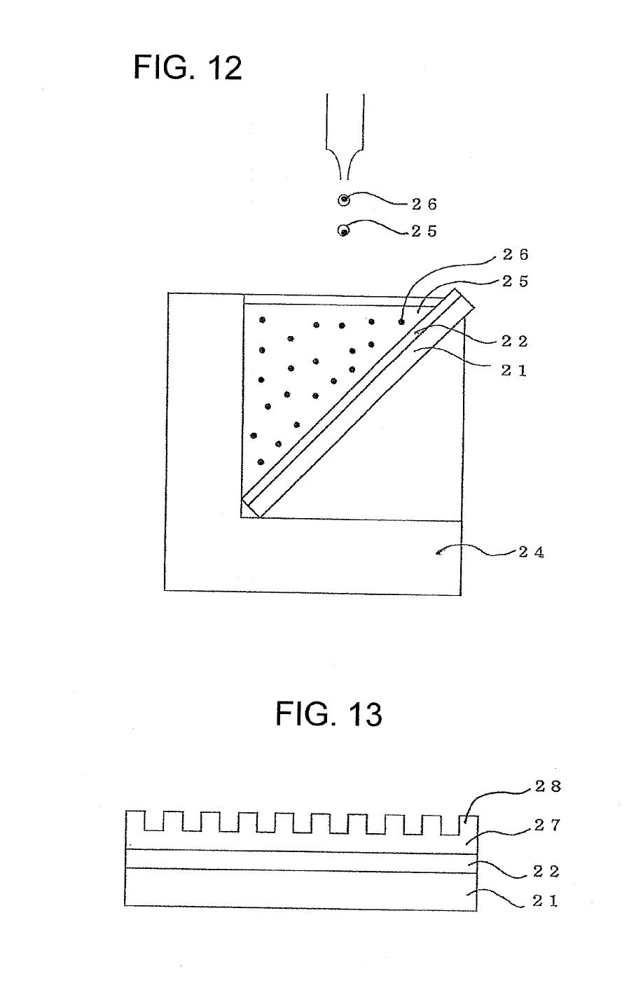

As shown in FIG. 12, by locating the substrate 21 on the blocking frame 24 in an inclined condition, when an aqueous photocatalyst solution 25 is applied as mentioned below, it is possible that an amount of the aqueous photocatalyst solution 25 accumulated on the substrate 21 varies with the position.

Therefore, in the case where the drying is carried out in a drying process mentioned below, steps are generated on a surface of a photocatalyst layer after an aqueous photocatalyst layer has been dried.

### <Process of Applying an Aqueous Photocatalyst Solution>

A process of applying an aqueous photocatalyst solution is a process of applying the aqueous photocatalyst solution 25 containing fine particles 26 on the titanium oxide layer 22 to form a photocatalyst layer 27 (step S24).

A process of applying the aqueous photocatalyst solution 25 is the same as a process explained in the first embodiment.

Here, it is a characterizing feature to apply the aqueous photocatalyst solution 25 on the titanium oxide layer 22 in such a way that a thickness of the aqueous photocatalyst solution 25 is ununiform.

As shown in FIG. 12, by applying the aqueous photocatalyst solution 25 in a condition in which the substrate 21 is located on the blocking frame 24 mentioned above in an inclined condition, a thickness to which the aqueous photocatalyst solution 25 is accumulated varies with the position on the substrate 21. Therefore, the aqueous photocatalyst solution 25 is applied on the titanium oxide layer 22 ununiformly.

Thus, in the case where the drying is carried out in a drying process mentioned below, it is possible to generate steps on a surface of the photocatalyst layer after the aqueous photocatalyst solution has been dried.

It is necessary that an amount of the aqueous photocatalyst solution 25 to be applied is larger than an amount of the aqueous photocatalyst solution 25 which are applied uniformly. An amount of the aqueous photocatalyst solution 25 is large in the case where the blocking frame 24 is used, and the aqueous photocatalyst solution 25 is applied in a condition where the substrate 21 is inclined and located, as compared with the case where the blocking frame 24 is not used, and the aqueous photocatalyst solution 25 is applied uniformly in a condition where the substrate 21 is located in a plane condition.

### <Drying Process>

The drying process is the same as the case explained in the first embodiment (step S14). The drying is carried out in a condition where the substrate 21 is located on the blocking frame 25.

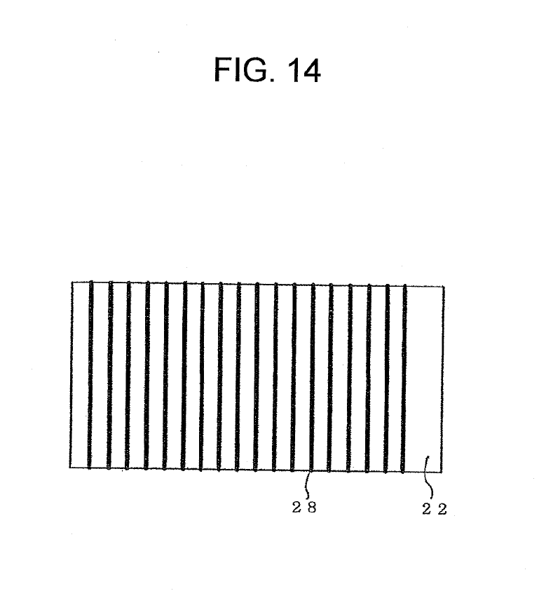

By such a drying process, a step 28 can be generated on a surface of the photocatalyst layer 27, as shown in FIG. 13, and FIG. 14.

It may be possible to provide a process of removing a blocking frame after a drying process.

As mentioned above, since the aqueous photocatalyst solution 9 contains fine particles 10, in the case where the drying is carried out in a drying process, a step 12 can be generated on a surface of the photocatalyst layer 11 after the aqueous photocatalyst solution 9 is dried. Further, by applying the aqueous photocatalyst solution 9 on the titanium oxide layer 6 in such a way that a thickness of the aqueous photocatalyst solution 9 is ununiform, when the drying is carried out, a boundary portion between the aqueous solution and the titanium oxide layer 6 moves gradually from a thin portion of the thickness of the aqueous solution, so that continuous steps can be generated on a surface of the phtocatalyst layer 11.

Thus, by generating a step 12, a surface area of the photocatalyst layer 11 can become large, and therefore, it is possible to dissolve and remove more material of an organic system (dirt) adhered to a surface of the substrate 1 which is a photocatalyst effect.

Further, the substrate 1 has a spherical shape, and by applying an amount of the aqueous photocatalyst solution 9 which is larger than an amount of the aqueous photocatalyst solution 9 which is applied uniformly, in the case where the drying is carried out in a drying process, a step can be generated on a surface of the photocatalyst layer 11 after the aqueous photocatalyst solution 9 has been dried.

Further, by applying an amount of the aqueous photocatalyst solution by which the top of the substrate having a spherical shape is covered, after the aqueous photocatalyst solution 9 has been dried, a step 12 can be also generated on a surface of the photocatalyst layer 11 in the vicinity of the top 4 of the substrate.

Further when the aqueous photocatalyst solution 9 is applied on the titanium oxide layer 22, by forming the blocking frame 7 for the aqueous photocatalyst solution 9 on the periphery of the substrate 1 in such a way that the aqueous photocatalyst solution 9 does not leak to the periphery of the substrate 1, the aqueous photocatalyst solution 9 does not leak to the periphery of the substrate 1 so that the aqueous photocatalyst solution 9 can be accumulated on the substrate 1. Thus, in the case where the drying is carried out in a drying process, a step can be generated on a surface of the photocatalyst layer 11 after the aqueous photocatalyst solution 9 has been dried.

Further, the substrate 21 is a plane shape, and when the aqueous photocatalyst solution 25 is applied on the titanium oxide layer 22, the blocking frame for the aqueous photocatalyst solution 25 is formed in such a way that the aqueous photocatalyst solution 25 does not leak to the outside of the substrate 21, and the substrate is located on the blocking frame 24 thus formed in an inclined condition. Thus, in the case where the drying is carried out in a drying process, a step can be generated on a surface of the photocatalyst layer 27 after the aqueous photocatalyst solution 25 has been dried.

### EXPLANATION OF REFERENCE NUMERALS

1: substrate (spherical shape)
2: flat portion
3: boundary between a flat portion and a curved portion
4: curved portion
5: top
6, 22: titanium oxide layer
7, 24: blocking frame
8, 23: ultraviolet ray
9, 25: aqueous photocatalyst solution
10, 26: photocatalyst fine particle
11, 27: photocatalyst layer
12, 28: step
21: plane-shaped substrate

1-5. (canceled)

6. A method of producing a photocatalyst layer, comprising:
a light irradiation process of irradiating an ultraviolet ray on a titanium oxide layer formed on a substrate,
an aqueous photocatalyst solution application process of applying an aqueous photocatalyst solution containing fine particles on the titanium oxide layer, and
a drying process of drying the aqueous photocatalyst solution to form a photocalalyst layer,
wherein in the aqueous photocatalyst solution application process, the aqueous photocatalyst solution is applied on the titanium oxide layer in such a way that a thickness of the aqueous photocatalyst solution is ununiform, and
in the drying process, when the drying is carried out, a boundary portion between the aqueous photocatalyst solution and the titanium oxide layer moves gradually from a portion of the aqueous photocatalyst solution whose thickness is thin.

7. A method of producing a photocatalyst layer according to claim 6,
wherein the substrate has a spherical shape, and
the aqueous photocatalyst solution application process is a process of applying an amount of the aqueous photocatalyst solution which is larger than an amount of the aqueous photocatalyst solution which is applied uniformly.

8. A method of producing a photocatalyst layer according to claim 6,
wherein the aqueous photocatalyst solution application process is a process of applying an amount of the aqueous photocatalyst solution by which a top of the substrate having the spherical shape is covered.

9. A method of producing a photocatalyst layer according to claim 6, further comprising:
a blocking frame forming process of forming a blocking frame for the aqueous photocatalyst solution on a periphery of the substrate to prevent the aqueous photocatalyst solution from leaking to the periphery of the substrate when the aqueous photocatalyst solution is applied on the titanium oxide layer.

10. A method of producing a photocatalyst layer according to claim 6,
wherein the substrate has a plane shape, and the method further comprises:
a blocking frame forming process of forming a blocking frame for the aqueous photocatalyst solution to prevent the aqueous photocatalyst solution from leaking to the outside of the substrate when the aqueous photocatalyst solution is applied on the titanium oxide layer, and
a substrate locating process of locating the substrate on the blocking frame formed in the blocking frame forming process in an inclined condition.
